(19) United States
(12) Patent Application Publication
(10) Pub. No.: US 2011/0239115 A1
(43) Pub. Date: Sep. 29, 2011

(54) SELECTING AN AVATAR ON A DISPLAY SCREEN OF A MOBILE DEVICE

(75) Inventors: Jay J. Williams, Glenview, IL (US); Renxiang Li, Lake Zurich, IL (US); Jingjing Meng, Evanston, IL (US)

(73) Assignee: MOTOROLA, INC., Schaumburg, IL (US)

(21) Appl. No.: 12/732,258

(22) Filed: Mar. 26, 2010

(51) Int. Cl. G06F 3/048; G06F 3/16; G06F 3/01

(52) U.S. Cl. 715/702; 715/830; 715/823; 715/728; 715/845

(57) ABSTRACT

Disclosed are techniques that allow the user of a mobile device to select an avatar within a virtual world presented on the display screen of the mobile device. In some embodiments, a user manipulates a thumbwheel. As the thumbwheel is turned, the avatars on the display screen are highlighted one after another. The user then presses a thumbwheel button to select a desired avatar. Some embodiments allow the user to select more than one avatar at a time. Several highlighting techniques are available. In some embodiments, the user uses speech commands instead of a thumbwheel to highlight the avatars one by one. Speech input is also used to select one or more avatars. Some devices support a touch-screen interface. Embodiments for these devices allow the user to select an avatar by, for example, drawing an arc enclosing the avatar.

### FIELD OF THE INVENTION

The present invention is related generally to user interfaces and, more particularly, to user interfaces on mobile devices.

### BACKGROUND OF THE INVENTION

Virtual worlds and the avatars that interact within them are becoming popular on desktop and laptop computers. Even businesses are starting to investigate how this new form of media communication can benefit the commercial arena. For example, a virtual world can be created that represents a virtual conference room. In the virtual conference room, each participant in a real conference call is represented by an avatar. By controlling his avatar, a participant can display emotions and body language in addition to providing speech. As a result, the participant presents himself in the conference call in a manner more compelling than is allowed by simple voice conferencing.

Participants control the expressions and movements of their avatars by using a standard computer keyboard and mouse. A stereo headset and microphone provide audio interaction with the other participants. The software supporting the virtual world uses spatial audio effects in the stereo headset to give each participant a feeling of locality within the virtual space. The audio effects also allow each participant to place the other avatars spatially within the virtual world so that each participant can identify which avatar is speaking. The microphone captures the participant's speech which is then provided to other participants in the virtual world in a manner similar to a voice bridge, usually after spatial-audio processing as mentioned above.

As virtual worlds become more popular, users will want to access them even when away from their standard computers. Mobile devices (e.g., smart telephones) are appearing that contain graphics processing units powerful enough to present a virtual world on the device's display screen.

Of course, the very nature of a mobile device presents some limitations in its ability to support virtual worlds. The smallness of the device's screen is an obvious example. The user's input capabilities are also limited. The device may have a keyboard that is limited either in the number of its keys or in its size. There is no room for a traditional mouse to roam. Also, the device is often subjected to a “jittery” environment as its user walks around while using it. This jitteriness prevents the use of very fine control, even if the device supports a mouse interface.

The user-input limitations inherent in mobile devices could cause problems when a user undertakes some common virtual-world tasks such as selecting one particular icon, e.g., an avatar, within a crowded display.

### BRIEF SUMMARY

The above considerations, and others, are addressed by the present invention, which can be understood by referring to the specification, drawings, and claims. According to aspects of the present invention, techniques are provided that allow the user of a mobile device to select an avatar within a virtual world presented on the display screen of the mobile device. The techniques, though not uniquely applicable to mobile devices, leverage the advantages of the user-input devices typically found on mobile devices while avoiding many of the limitations inherent in the size factor of the mobile device.

In some embodiments, a user manipulates a thumbwheel. As the thumbwheel is turned, the avatars on the display screen are highlighted one after another. The user then presses a thumbwheel button to select a desired avatar. Some embodiments allow the user to select more than one avatar at a time in order to, for example, talk to some, but maybe not all, of the avatars currently shown on the screen.

Several highlighting techniques are available. The graphics capability of the mobile device can be invoked to draw a contrasting border to highlight an avatar, or the avatar can be highlighted by rendering it brighter or in false colors. In more sophisticated embodiments, an avatar can be highlighted by causing it to respond, e.g., by blinking or by waving a hand.

Feedback can be given to a user to confirm the user's selection of an avatar. Examples of feedback include a change in the appearance of the avatar, a sound or spoken response, or a haptic response.

In some embodiments, the user uses speech commands instead of a thumbwheel to highlight the avatars one by one. Speech input is also used to select one or more avatars.

Some devices support a touch-screen interface. Embodiments for these devices allow the user to select an avatar by, for example, drawing an arc enclosing the avatar. In many environments, drawing a rough arc is easier than trying to touch the screen at a precise point.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is a display view of a representative virtual environment with two avatars;

FIG. 2 is a flowchart of a first exemplary method for selecting an avatar in a virtual environment;

FIGS. 3a and 3b are display views of the virtual environment of FIG. 1 showing one and both avatars highlighted, respectively;

FIG. 4 is a front/side/back view of a representative mobile device;

FIG. 5 is a flowchart of a second exemplary method for selecting an avatar; and

FIG. 6 is a flowchart of a third exemplary method for selecting an avatar.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

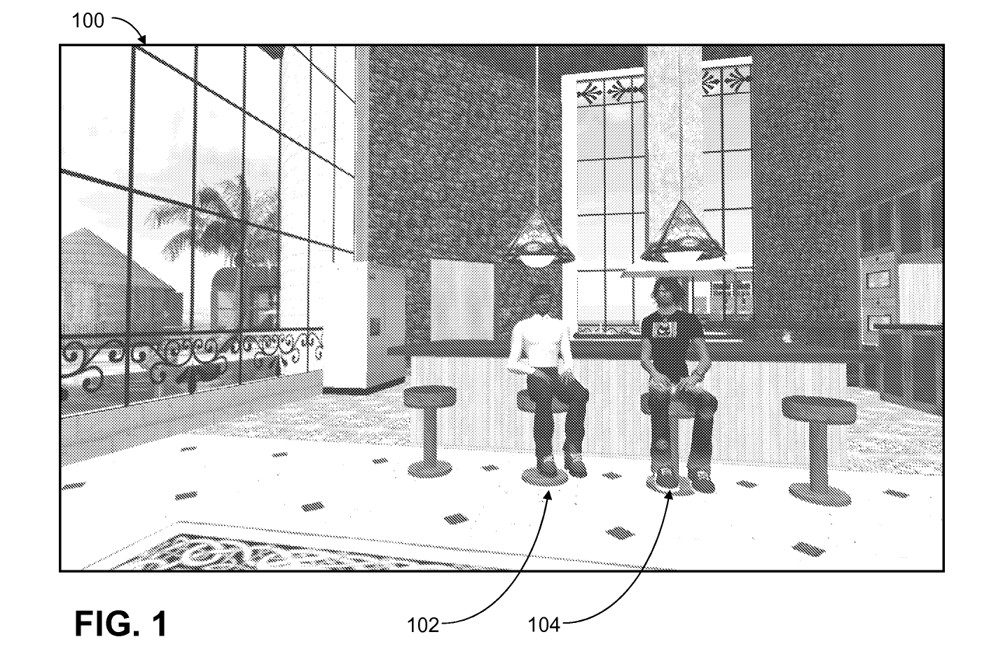

FIG. 1 is a scene from a virtual world. Some primitive virtual worlds are constrained to two dimensions, but as graphics capabilities increase, three-dimensional worlds are becoming the norm. The virtual world depicted can be of any nature such as a game, an arena for a social interactions, or a commercial application such as a virtual conference call. The virtual-world scene is shown on a display screen 100 of a mobile device. The nature of the present discussion only allows the portrayal of static scenes, but, as is well known, virtual worlds can be in constant motion, with items in them constantly moving about and coming and going.

Within the scene of FIG. 1 are two avatars 102 and 104. In some situations, many other avatars may be present. While the two avatars 102 and 104 are shown sitting down as if waiting to be chosen, in some embodiments of the virtual world, these avatars 102 and 104 may be in motion or may be gesturing to the user.

The user of the mobile device whose screen 100 is shown in FIG. 1 wishes to choose one or more of the avatars 102, 104. There are several possible reasons for choosing an avatar: The user may choose one of the avatars 102, 104 to represent himself in the virtual world. Or the user may already have an avatar but may wish to start a conversation that, instead of being broadcast to everyone in the virtual world, is limited to a chosen set of avatars.

The user in this scenario is interacting with the virtual world by means of a mobile device, and that mobile device supports a limited set of input and output capabilities for the user. For example, the size of the display 100 of the mobile device is typically much smaller than that on a standard personal computer. The mobile device in typical use is more jittery than a desktop PC or even a laptop would be, making fine input control more difficult.

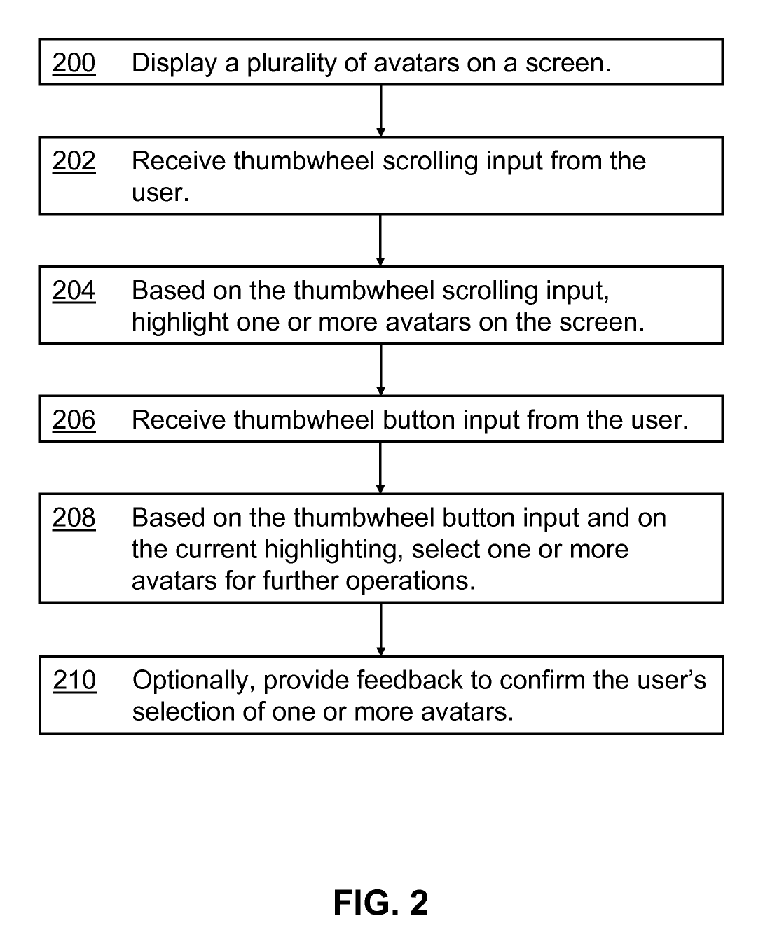

FIG. 2 presents a first method for choosing an avatar displayed on a mobile device. This method uses a thumbwheel to avoid the user-interface limitations of the mobile device. The method of FIG. 2 begins in step 200 where the avatars 102, 104 are shown on the display screen 100 of the mobile device, as in FIG. 1. In step 202, the user rotates the thumbwheel to advance his “focus” from one avatar to another in sequence. Note that this advancing is made possible by the fact that the number of avatars in a scene is both finite and discrete. The particular method used by the mobile device to decide which avatar is “next” in the sequence should be intuitive but may depend on the particular locations of the avatars in the virtual world. In the scene of FIG. 1, the sequence can proceed from left to right when the thumbwheel is turned one way, and from right to left when the thumbwheel is turned the other way.

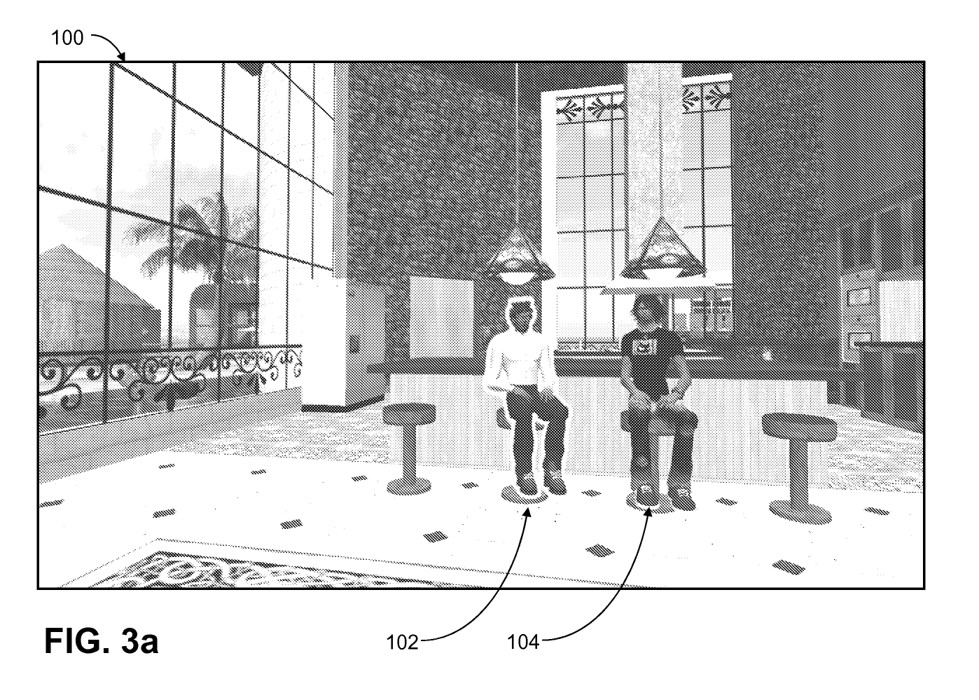

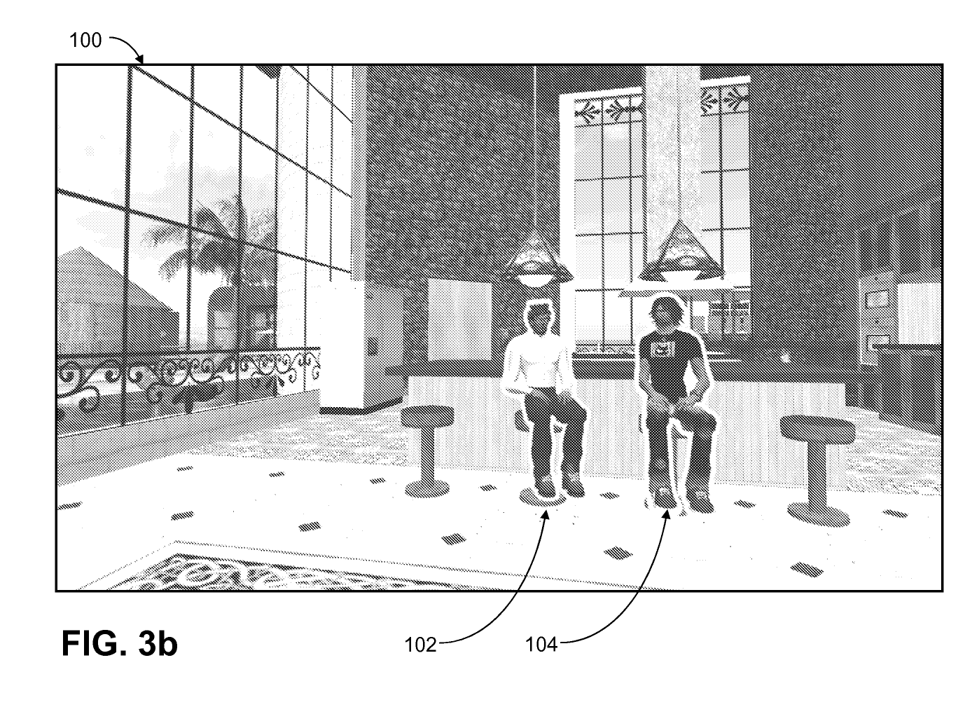

In step 204, the user is shown that a particular avatar is under focus at the moment by “highlighting” that avatar in one way or another. Several embodiments of highlighting are possible. In the embodiment of FIG. 3a, a contrasting border is drawn around the avatar 102 to highlight him. Other embodiments can otherwise alter the visual appearance of the avatar currently under focus by, for example, brightening him relative to the rest of the virtual-world scene or depicting him in false colors. Sophisticated mobile devices can even use gestures or other motion to highlight an avatar. For example, the avatar 102 of FIG. 1 can be highlighted by causing him to blink, wave his hand, or even stand up.

In some embodiments, more than one avatar can be under focus at the same time. This is illustrated in FIG. 3b where both avatars 102, 104 are highlighted with contrasting borders. The user can direct the mobile device by typing a key (e.g., the shift key) or by some other input to say that he wishes to add an avatar to the current list of avatars under focus.

In step 206 of FIG. 2, the user pushes the thumbwheel button to indicate his selection of the currently highlighted avatar(s). At step 208, the highlighting that indicates focus is removed. (Although, in some embodiments, the selected avatar(s) can be highlighted as feedback to the user: See the description accompanying step 210 below.) Techniques can be supported whereby the user easily selects or deselects all of the avatars currently depicted. In step 208, the user can begin to use the selected avatar(s) in ways well known to participants in virtual worlds. In one example, the selected avatar 102 begins to represent the user in the virtual world. In a second example, the user begins a private conversation with the selected avatars 102, 104, and only with those selected avatars. Further leveraging the particular user interface of the mobile device, in some embodiments the user pushes a dedicated Push-to-Talk button to speak to the selected avatar(s).

Optionally, in step 210 the user is given some feedback to confirm his selection. The selected avatar(s) can be visually highlighted on the display 100 when the selection is made, or the user can be given a one-time feedback such a tone, verbal message, or haptic response.

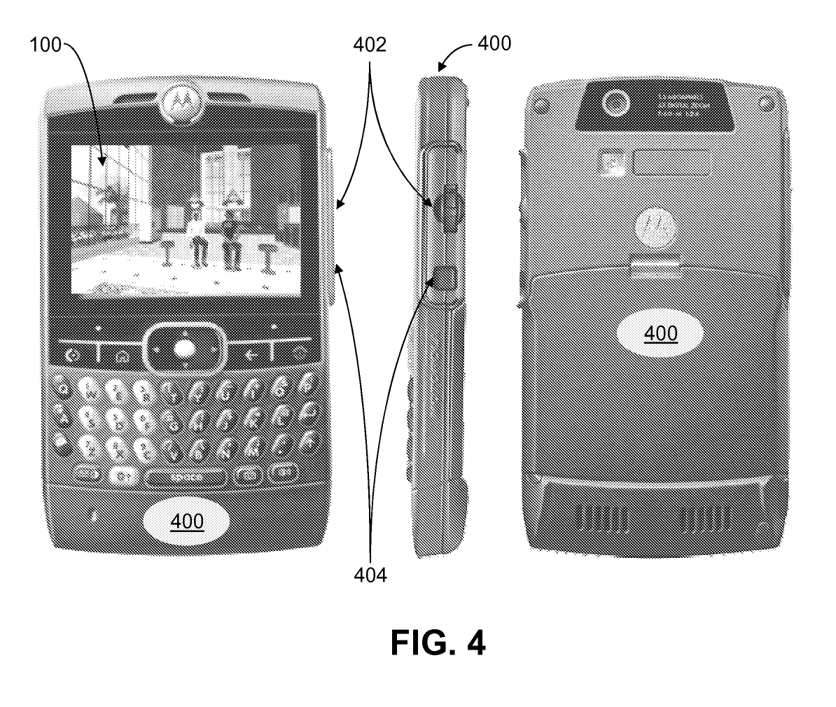

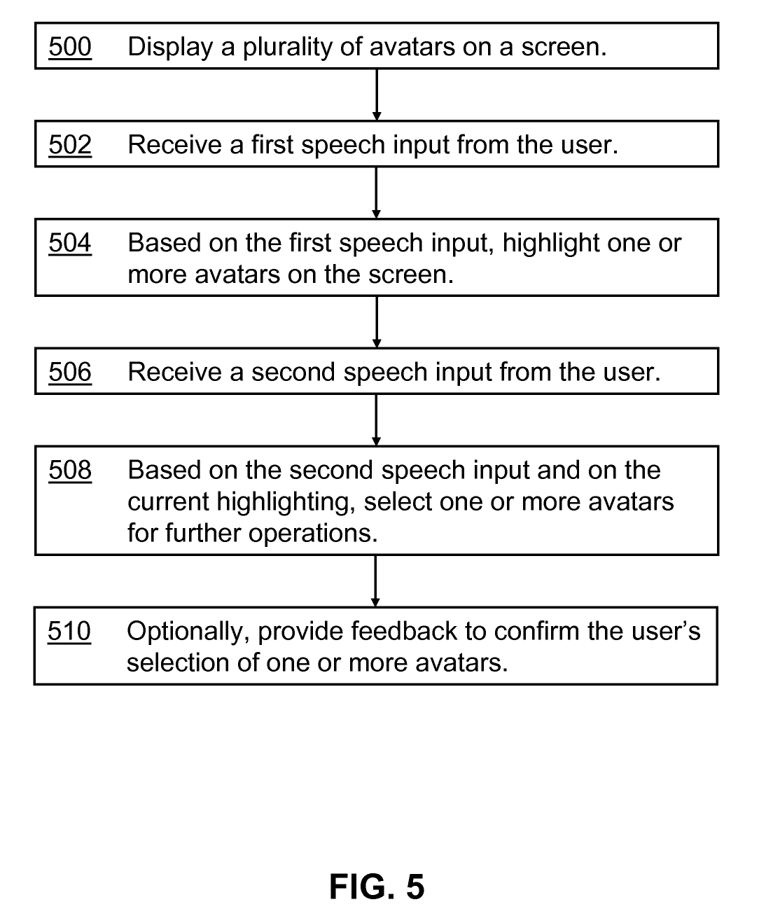

FIG. 4 shows a representative mobile device 400 that supports aspects of the present invention. While the display screen 100 and the keypad are bigger than those on most mobile devices, they are still much smaller than on a traditional computer. The display screen 100, in some embodiments, is a touch-input screen. The thumbwheel 402 is shown on the right side of the device 400. The thumbwheel 402 can be scrolled backward or forward and can be pushed in to provide button input. A speech recognition key 404 (see the discussion accompanying FIG. 5) sits next to the thumbwheel 402. Some embodiments of the mobile device 400 include a Push-to-Talk button (not shown). Internally, the mobile device 400 includes a processor, memory, battery, microphone, speaker, and a communications transceiver (not shown), all well known in the art. Some mobile devices 400 include a haptic response unit (not shown).

FIG. 5 presents an alternative method for selecting avatars on the mobile device 400. The device 400 displays the avatars on the display screen 100 in step 500. In steps 502 and 504, the user's speech is used to move the focus from one avatar to another. For example, the user may press a Push-to-Talk button and then say a command, such as “next” and “back” that move the focus. “Add” can be spoken to highlight multiple avatars. Some embodiments may understand richer commands such as “highlight [or select] the avatar on the right” or “give me the one with the red shirt.” In step 506, the user speaks again to make a selection. The possible commands “select,” “select all,” and “deselect all” have clear meanings As above, the user's selection is noted in step 508 and optionally confirmed in step 510.

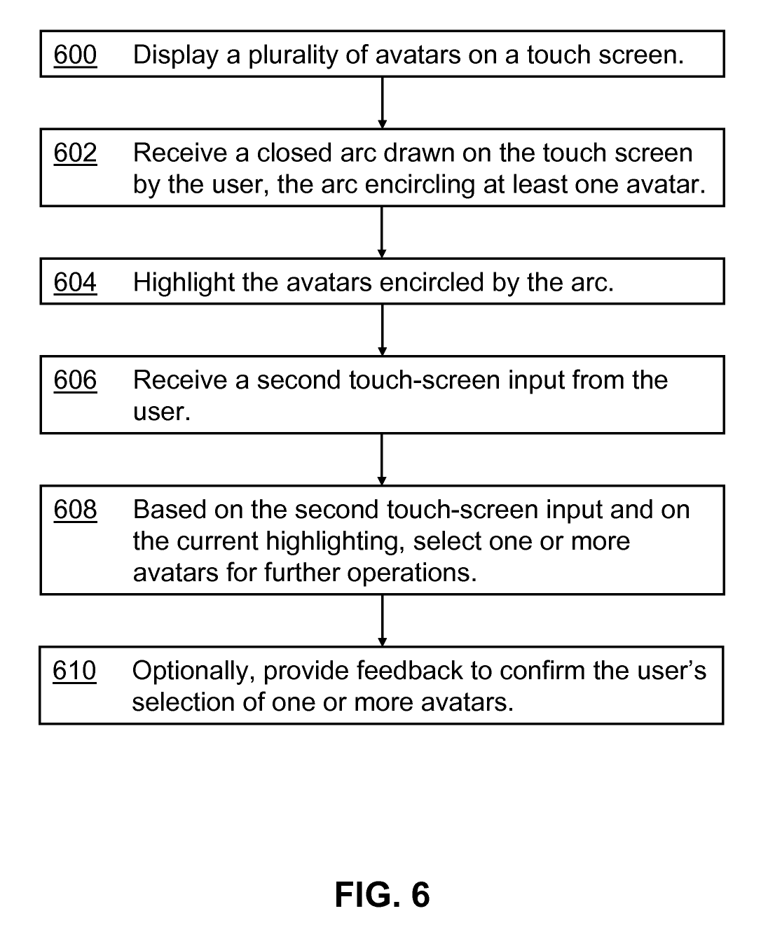

FIG. 6 presents yet another method for selecting avatars. As before, the avatars are shown on the display screen 100 in step 600. In the method of FIG. 6, the display screen 100 is touch sensitive. The user, in step 602, draws an arc around one or more avatars to focus on them. The encircled avatars are highlighted in step 604 using any of the highlighting methods discussed above. The user again touches the screen 100 to make a selection in step 606. For example, a “double tap” within the drawn arc could indicate that all of the encircled avatars are selected. The user's selection is noted in step 608 and optionally confirmed in step 610.

In view of the many possible embodiments to which the principles of the present invention may be applied, it should be recognized that the embodiments described herein with respect to the drawing figures are meant to be illustrative only and should not be taken as limiting the scope of the invention. For example, the techniques of FIGS. 2, 5, and 6 can be combined so that, for example, the user thumbs the wheel to move the focus and speaks to make a selection. Therefore, the invention as described herein contemplates all such embodiments as may come within the scope of the following claims and equivalents thereof.

We claim:

1. A method for selecting and using at least one of a plurality of avatars presented on a display screen of a mobile device of a user, the mobile device comprising a thumbwheel input device, the method comprising:
depicting, on the display screen of the mobile device, a plurality of avatars;
receiving thumbwheel scrolling input from the user;
based, at least in part, on the received thumbwheel scrolling input, highlighting at least one of the avatars on the display screen of the mobile device;
receiving thumbwheel button input from the user;
based, at least in part, on the received thumbwheel button input and on the current highlighting, selecting at least one avatar; and
using the selected at least one avatar in a virtual environment.

2. The method of claim 1 wherein highlighting an avatar comprises an element selected from the group consisting of: causing the avatar to blink, displaying an outline around the avatar, changing a lighting of the avatar, and otherwise changing an appearance of the avatar.

3. The method of claim 1 wherein, based on input from the user, a plurality of avatars are simultaneously highlighted.

4. The method of claim 1 wherein, based on input from the user, a plurality of avatars are simultaneously selected.

5. The method of claim 1 further comprising:
providing feedback to the user, the feedback based, at least in part, on a selection of an avatar by the user.

6. The method of claim 5 wherein the feedback is selected from the group consisting of: a haptic response, a sound, a spoken response, and a change in the display.

7. A method for selecting and using at least one of a plurality of avatars presented on a display screen of a mobile device of a user, the mobile device comprising a speech input device, the method comprising:
depicting, on the display screen of the mobile device, a plurality of avatars;
receiving a first speech input from the user;
based, at least in part, on the received first speech input, highlighting at least one of the avatars on the display screen of the mobile device;
receiving a second speech input from the user;
based, at least in part, on the received second speech input and on the current highlighting, selecting at least one avatar; and
using the selected at least one avatar in a virtual environment.

8. The method of claim 7 wherein, based on speech input from the user, a plurality of avatars are simultaneously highlighted.

9. The method of claim 7 wherein, based on speech input from the user, a plurality of avatars are simultaneously selected.

10. A method for selecting and using at least one of a plurality of avatars presented on a display screen of a mobile device of a user, the mobile device comprising a touch screen, the method comprising:
depicting, on the display screen of the mobile device, a plurality of avatars;
receiving a first touch-screen input from the user, the first touch-screen input comprising a closed arc surrounding at least one avatar;
based, at least in part, on the received first touch-screen input, highlighting, on the display screen of the mobile device, at least one avatar surrounded by the closed arc;
receiving a second touch-screen input from the user;
based, at least in part, on the received second touch-screen input and on the current highlighting, selecting at least one avatar; and
using the selected at least one avatar in a virtual environment.

11. The method of claim 10 wherein the closed arc surrounds a plurality of avatars.

12. The method of claim 10 wherein, based on touch-screen input from the user, a plurality of avatars are simultaneously selected.

13. A mobile device comprising:
a display screen;
a thumbwheel input device; and
a processor operatively coupled to the display screen and to the thumbwheel input device, the processor configured for:
depicting, on the display screen, a plurality of avatars;
receiving thumbwheel scrolling input from a user of the mobile device;
based, at least in part, on the received thumbwheel scrolling input, highlighting at least one of the avatars on the display screen;
receiving thumbwheel button input from the user; and
based, at least in part, on the received thumbwheel button input and on the current highlighting, selecting at least one avatar.

14. The mobile device of claim 13 further comprising:
a haptic device operatively coupled to the processor;
wherein the processor is further configured for:
providing, via the haptic device, feedback to the user, the feedback based, at least in part, on a selection of an avatar by the user.

15. The mobile device of claim 13 further comprising:
a speaker operatively coupled to the processor;
wherein the processor is further configured for:
providing, via the speaker, feedback to the user, the feedback based, at least in part, on a selection of an avatar by the user.

16. A mobile device comprising:
a display screen;
a speech input device; and
a processor operatively coupled to the display screen and to the speech input device, the processor configured for:
depicting, on the display screen, a plurality of avatars;
receiving a first speech input from a user of the mobile device;
based, at least in part, on the received first speech input, highlighting at least one of the avatars on the display screen;
receiving a second speech input from the user; and
based, at least in part, on the received second speech input and on the current highlighting, selecting at least one avatar.

17. The mobile device of claim 16 further comprising:
a speaker operatively coupled to the processor;
wherein the processor is further configured for:
providing, via the speaker, feedback to the user, the feedback based, at least in part, on a selection of an avatar by the user.

18. A mobile device comprising:
a touch/display screen; and
a processor operatively coupled to the touch/display screen, the processor configured for:
depicting, on the touch/display screen, a plurality of avatars;
receiving a first touch-screen input from a user of the mobile device, the first touch-screen input comprising a closed arc surrounding at least one avatar;
based, at least in part, on the received first touch-screen input, highlighting, on the touch/display screen, at least one avatar surrounded by the closed arc;
receiving a second touch-screen input from the user; and
based, at least in part, on the received second touch-screen input and on the current highlighting, selecting at least one avatar.
